(19) United States
(12) Patent Application Publication
(10) Pub. No.: US 2012/0262920 A1
(43) Pub. Date: Oct. 18, 2012

(54) Lighting Assembly for New and Retrofitting Applications

(76) Inventor: William J. Longardner, Indianapolis, IN (US)

(21) Appl. No.: 13/446,762

(22) Filed: Apr. 13, 2012

Related U.S. Application Data
(60) Provisional application No. 61/475,424, filed on Apr. 14, 2011.

(51) Int. Cl. F21V 21/00; F21V 17/10; F21V 17/06

(52) U.S. Cl. 362/249.01; 362/370; 248/220.21; 29/401.1

(57) ABSTRACT

The present invention involves a retrofit lighting assembly for use with conventional lighting assemblies. The retrofit lighting assembly includes a base configured to engage the conventional lighting assembly socket, and a bracket assembly coupled to the base. The bracket is expandable so that once the base is secured inside the lighting assembly housing it may expand for attachment to the housing.

### CROSS-REFERENCE TO RELATED APPLICATIONS

This application is a utility of U.S. Provisional Patent Application No. 61/475,424 which was filed Apr. 14, 2011 the disclosures of which are hereby incorporated by reference herein in its entirety.

### BACKGROUND OF THE INVENTION

1. Field of the Invention

The present invention relates generally to a lighting assembly and, more particularly, to a lighting assembly for new and retrofitted fixtures.

2. Background Art

Conventional outdoor lighting assemblies having High Intensity Display (HID) lights may be used as roadway lamps, parking lamps, or security lamps used to enhance safety in certain areas. In addition to roadway, parking, and security applications, HID lights may further be used for decorative or general illumination applications. Typical HID outdoor lighting. assemblies are designed for use with high wattage lights sources, for example Metal Halide (MH), High Pressure Sodium (HPS), Low Pressure Sodium (LPS), and Mercury Vapor (MV) lighting. Incandescent or fluorescent bulbs also may be used. Such lighting is typically mounted in a socket disposed in fixtures including shoe box (a generic term for a rectangular outdoor area light used mostly in parking areas) fixtures, cobra fixtures, decorative fixtures, post top fixtures, acorn fixtures, lantern fixtures, wall pack fixtures, dusk to dawn fixtures, outdoor signage fixtures, and security light fixtures.

### SUMMARY OF THE INVENTION

Conventional HID lighting assemblies may not be configured to support and illuminate more efficient light sources that utilize electrical connectors other than a conventional socket (e.g., LED, plasma, induction lighting). In order to use more efficient light sources to illuminate a particular area, the entire HID lighting assembly may need to be removed, which adds to the expense of providing energy efficient lighting options.

According to an illustrative embodiment of the present invention, a retrofit lighting assembly arrangement is capable of using an existing lighting assembly to support an alternative light source. The retrofit lighting assembly includes a base for coupling to the existing lighting assembly socket. The retrofit lighting assembly further includes a bracket assembly capable of connection to the socket coupling and configured to support an Advanced Lighting Technology (ALT) light source within the existing conventional lighting assembly. In one embodiment, the coupling to the existing lighting assembly socket includes a threaded cylinder internally engaging the socket. In another embodiment, the coupling to the existing lighting assembly socket includes a sleeve that externally engages the socket to secure the coupling to the lighting assembly.

According to another illustrative embodiment of the present invention, a shoe box housing assembly is retrofit by a plug assembly being inserted within a socket of the shoe box housing assembly. The retrofit lighting assembly further includes a bracket assembly coupled to the plug assembly and configured to support an Advanced Lighting Technology (ALT) light source within the shoe box housing assembly. In an alternative embodiment, the plug assembly is secured about the exterior of the socket of the shoe box, for example by crimping or gluing.

According to a further illustrative embodiment of the present invention, the retrofit lighting assembly is a cobra lighting unit that includes a plug assembly threadedly coupled to a socket of the existing lighting assembly. The retrofit lighting assembly further includes a bracket coupled to the plug assembly and configured to support an Advanced Lighting Technology (ALT) light source within the existing lighting assembly.

An advantage of the embodiments of the invention involve using the existing fixtures with their established position, orientation, and reflectors, so that existing customizations are preserved and the retrofit lighting assembly provides a new lighting source.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is plan view one embodiment of a bracket assembly of the present invention.

FIG. 2A is an exploded perspective view of an embodiment of a plug assembly of the present invention.

FIG. 2B is an exploded perspective view of another embodiment of a plug assembly of the present invention.

FIG. 3A is a top plan view of a cobra lighting unit with an embodiment of the present invention.

FIG. 3B is a top plan view of a cobra lighting unit with an embodiment of the present invention in an installed position.

FIG. 4 is a bottom plan view of a shoe box lighting unit with an embodiment of the present invention.

FIG. 5 is a perspective view of one embodiment of a bracket assembly of the present invention.

FIGS. 6A-D are perspective, top plan, side, and end views of a component of one embodiment of the bracket assembly of the present invention.

FIG. 7 is a perspective view of another embodiment of a bracket assembly of the present invention.

FIGS. 8 A-D are perspective, top plan, side, and end views of a component of one embodiment of the bracket assembly of the present invention.

FIG. 9 is a perspective view of an embodiment of the bracket assembly of the present invention with multiple couplers.

FIG. 10 is an exploded view of the embodiment of FIG. 9.

FIGS. 11A-D A-D are perspective, top plan, side, and end views of a component of one embodiment of the bracket assembly of the present invention.

FIG. 11E is a perspective view of one embodiment of a corner piece used with the embodiment of FIGS. 11A-D.

FIG. 12 is a bottom view of a shoe box lighting unit of another embodiment of the present invention.

FIG. 13 is a plan view of the lighting unit of FIG. 12.

FIG. 14 is a further embodiment of the bracket assembly of the present invention deployed on a acorn-type lighting unit.

FIG. 15 is a bottom plan view of a cobra lighting unit with one embodiment of the bracket assembly of the present invention installed.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

The illustrative embodiment lighting assemblies described herein are retrofitted with an existing medium base, Mogul base, or other “standard” lamp socket system, including a High Intensity Display (HID) lighting assembly, for example, in order to use more efficient lighting options within an existing lighting assembly. However, the illustrative embodiments of the present disclosure also may be used with new, rather than existing, lighting assemblies that include a “standard” lamp design. Many outdoor lighting assemblies use HID lights, for example Metal Halide (MH), High Pressure Sodium (UPS), Low Pressure Sodium (LPS), and Mercury Vapor (MV), for roadway, parking lot, navigation, outdoor, signage, and decorative applications. However, the energy consumed by HID lights, fluorescent bulbs, and incandescent bulbs may be higher than other, more efficient lighting assemblies, such as LED, induction, plasma, or other Advanced Lighting Technology (ALT) light sources that consume less energy when illuminated. For example, an HID lighting assembly may use 150 Watt (W) metal halide lamps but an induction light system may use only 80 W. The illustrative embodiment lighting assembly described herein may be used to retrofit an existing lighting assembly or unit (e.g., an HID unit) with an ALT light source. More particularly, the illustrative lighting assembly is configured to be coupled with the existing power source and/or a housing of the existing HID lighting unit to provide an electrical connection to ALT lamps and light sources. Alternatively, the illustrative lighting assembly may be used with new lighting units, rather than being retrofitted with existing units, in order to provide a new conventional lighting fixture with an ALT light source.

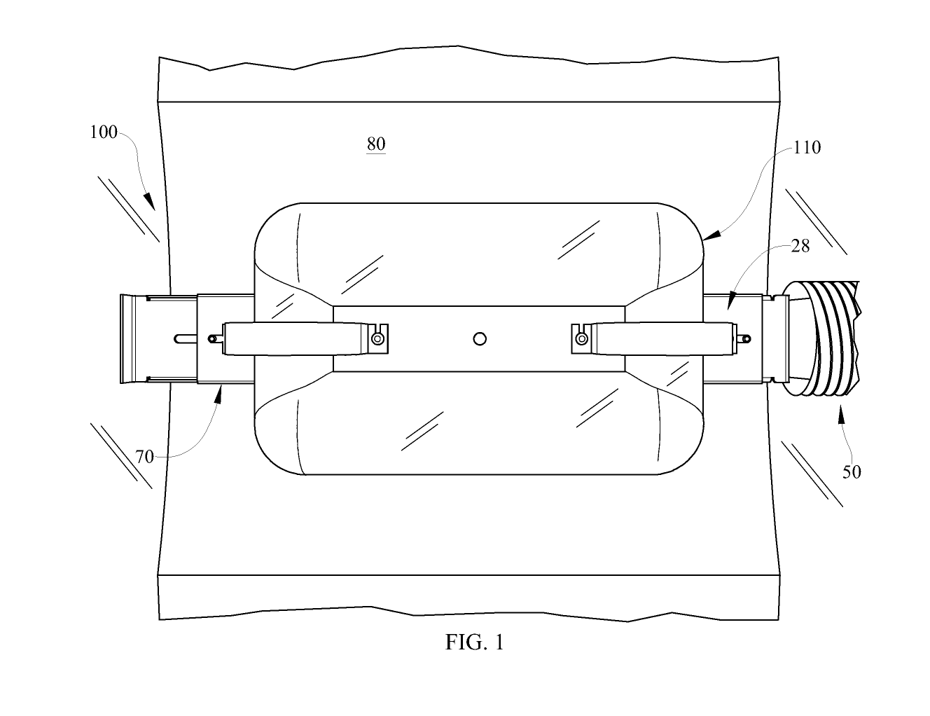

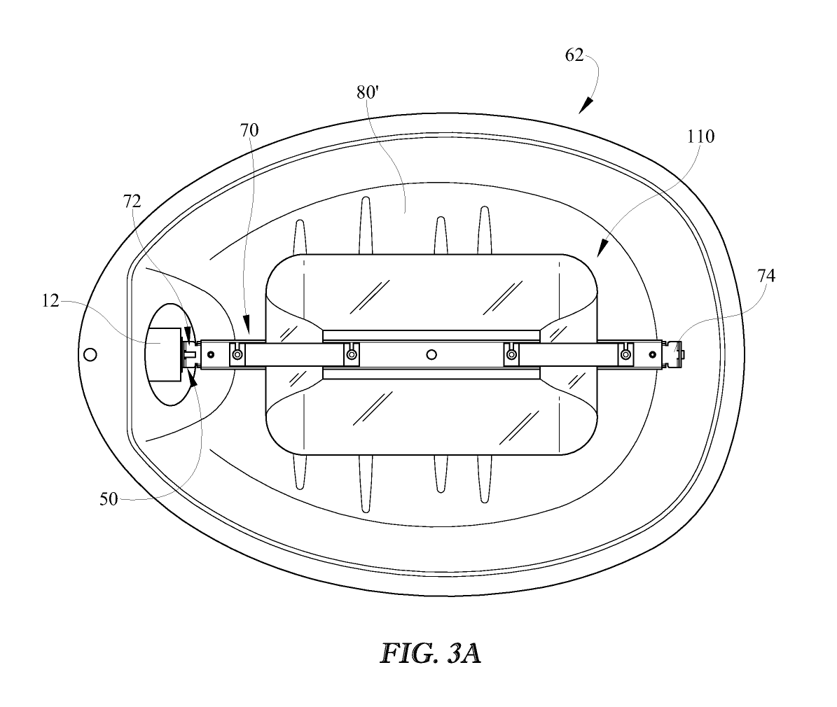

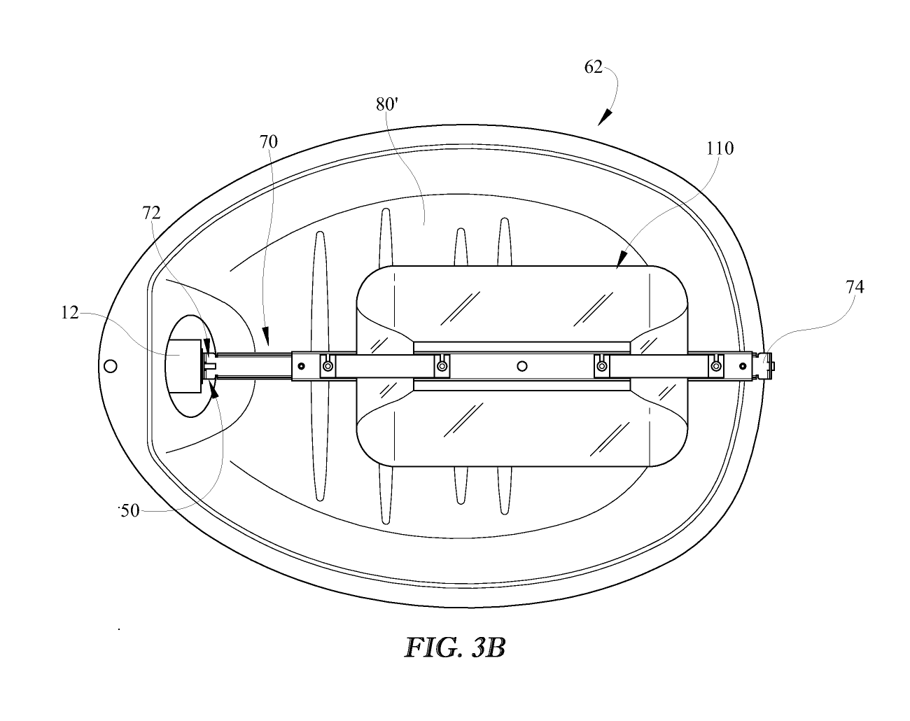

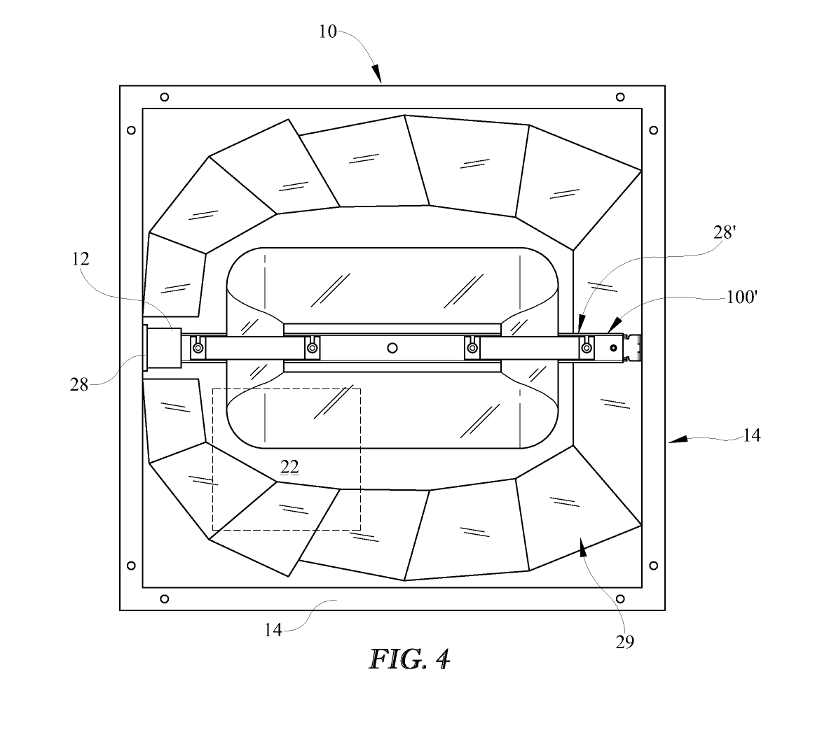

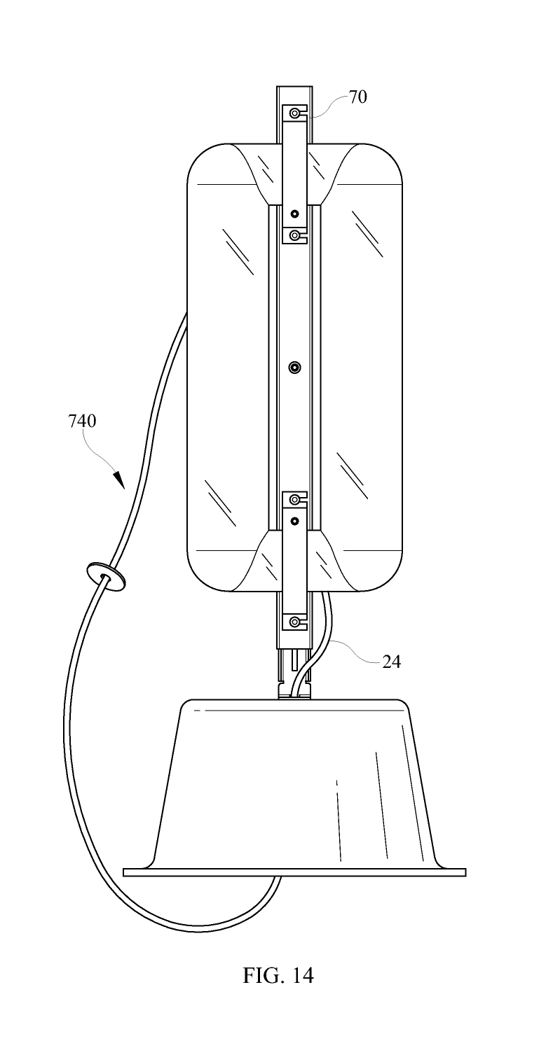

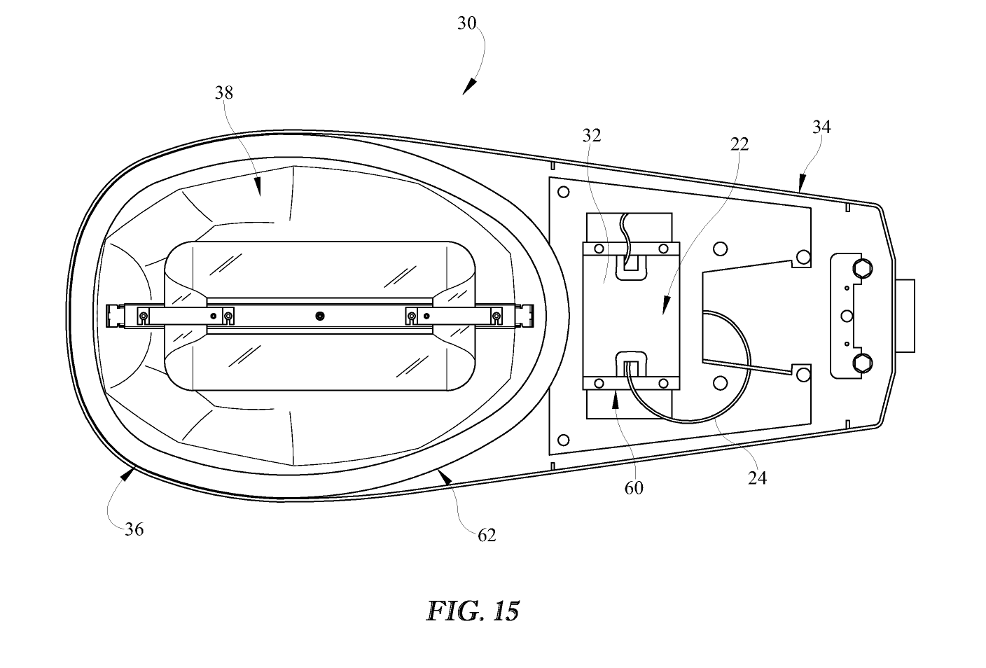

The Figures show illustrative embodiments of retrofit lighting assembly 100. With reference to FIG. 1, retrofit lighting assembly 100 includes ALT light source 110 coupled to bracket assembly 70. In this exemplary embodiment, ALT light source 110 is an induction lighting system, however, LED, plasma, or other energy efficient lighting options may be used. Bracket assembly 70 may be further coupled to plug or base assembly 50 such that both bracket assembly 70 and plug assembly 50 are mechanically coupled to an existing HID lighting unit (not shown). In this way, the illustrative retrofit lighting assembly 100 shown herein may provide inexpensive “green” lighting solutions by decreasing energy consumption and utilizing the structure of the existing HID lighting unit, for example reflective receptacle 29. Retrofit lighting assembly 100 is illustratively shown with an existing HID lighting unit, such as, a shoe box lighting unit (FIGS. 4, 12, and 13) and a cobra lighting unit (FIGS. 3A, 3B, and 15). Other lighting unit fixtures that also may be retrofitted with lighting assembly 100 include Decoratives, Post Tops, Acorns (FIG. 14), Lanterns, Wall Packs, Dusk to Dawns, Security Lights, Outdoor Signage, and other fixtures using HID lights.

As shown in FIG. 4, an exemplary embodiment is disposed in shoe box lighting unit 10 is typically used for parking area lighting applications and includes socket 12, enclosed housing 14, a generator (not shown in FIG. 4, see 22 in FIG. 15), reflective receptacle 29, and mounting plate 28 for socket 12. At least socket 12, housing 14, reflective receptacle 29, and plate 28 are components of the original, existing HID lighting assembly that is being retrofitted with lighting assembly 100. Socket 12 within housing 14 is electrically coupled to a power source (not shown) to supply electricity to the original conventional lighting assembly by appropriate wiring. Ballast generator 22 may be provided within housing 14 to supply power to light source 110, or alternatively generator 22 may be externally mounted. Generator 22, light source 110, and the power source may be conventionally electrically coupled.

An alternative embodiment of shoe box lighting unit 10 makes use of at least one reflector panel 80 (FIG. 1) rather than reflective receptacle 29. Reflector panel 80 reflect light from light source 110 when positioned adjacent to retrofit lighting assembly 100 and positioned within housing 14 of shoe box lighting unit 10. Reflector panel 80 is provided to direct light outwardly from housing 14 and facilitate illumination of a particular area. Reflector panel 80 is positioned with deliberate orientation relative to socket 12 and light source 110 in order to maximize the amount of light being emitted from shoe box lighting unit 10. Reflector panel 80 is coupled to housing 14 with conventional couplers (e.g., screws, welds, adhesive). This allows the installer to optionally choose whether the existing reflectors are suitable for the retrofit lighting unit or if replacement reflectors are a better choice.

Alternatively, reflective receptacle 29 may be provided within housing 14 to further facilitate light emission. Receptacle 29 may either be comprised of reflective material or lined with reflective material in order to project light from housing 14, thereby providing a similar function as reflector panel 80. Reflective receptacle 29 is positioned relative to the location of socket 12 to support light source 110 therein and project light outwardly from housing 14. Therefore, as with reflector panel 80, reflective receptacle 29 encourages the maximum amount of light to be outputted from shoe box light unit 10. Receptacle 29 receives ALT light source 110 after the HID light source has been removed from housing 14.

Socket 12 is initially coupled to the original light source (e.g., incandescent light bulb, metal halide, or HPS lamp) (not shown) within housing 14 to supply electricity to the light source. Housing 14 of shoe box lighting unit 10 cooperates with socket 12 to effectively maximize the amount of light being emitted from housing 14. More particularly, socket 12 is oriented and positioned within housing 14 such that a maximum amount of light may be cast therefrom. As such, socket 12 determines the location of the light source (i.e., the location and direction of the light projected outwardly). Socket 12 may be mounted to mounting plate 28 to further secure a light source within housing 14. As such, retrofit lighting assembly 100 also makes use of socket 12 and/or mounting plate 28 to properly secure and orient ALT light source 110 when the HID light source is removed.

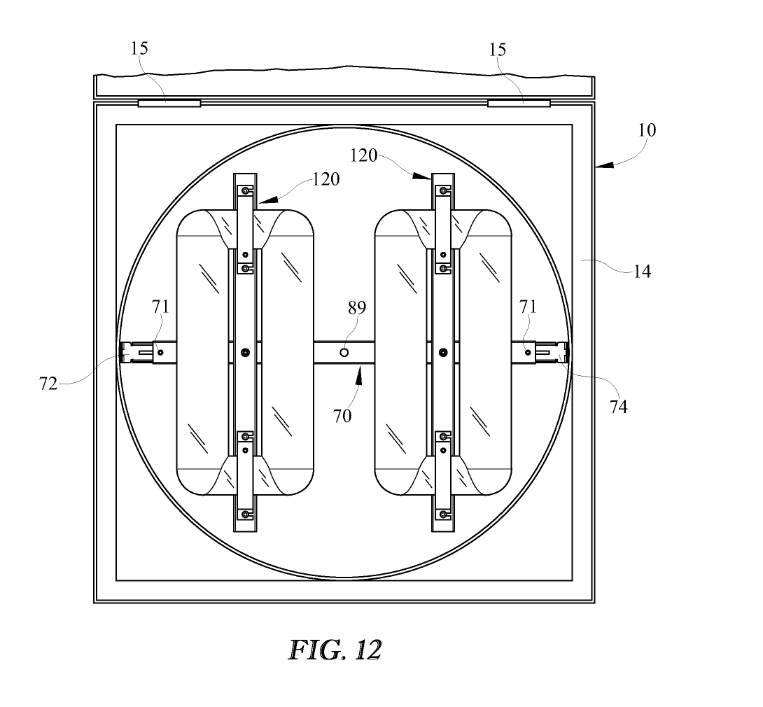

Housing 14 includes a plurality of side walls, a top surface, and a bottom surface which may be configured as a rectangular or square prism. In some embodiments, the bottom surface may include a lens (not shown) made from transparent material in order to emit and focus light from shoe box lighting unit 10. Conversely, the side walls and top surface may be comprised of an opaque material. Walls, top surface, and bottom surface are typically comprised of weather resistant material when shoe box lighting unit 10 is used for outdoor lighting applications. The bottom surface may be coupled to one of the side walls with hinge assembly 15 (FIG. 12) such that the bottom surface may pivot to an open position about hinge 15, thereby making the inside of housing 14 accessible.

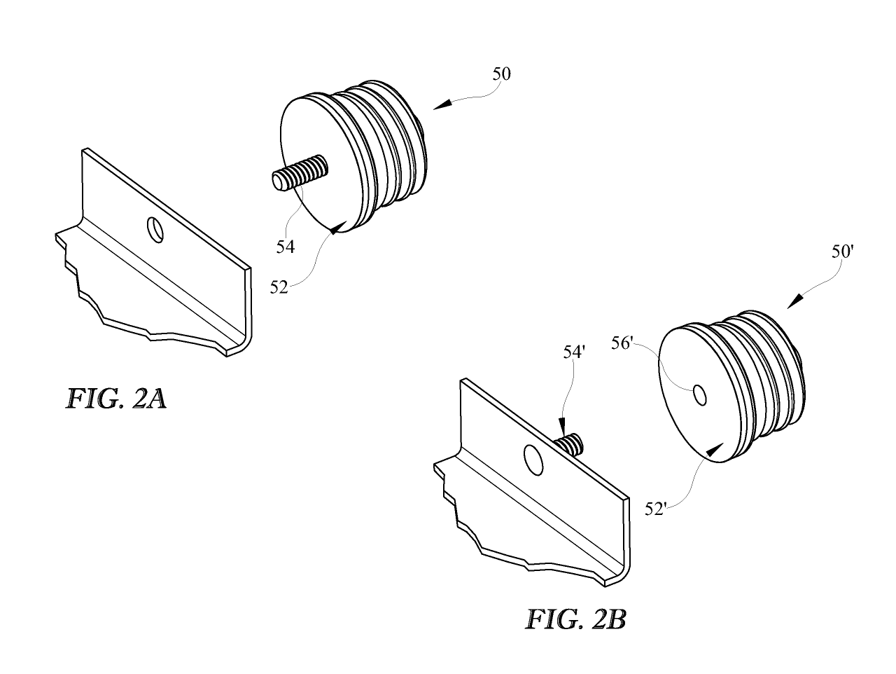

Referring to FIGS. 2A and 2B, illustrative plug assembly 50 and 50′ are provided as part of retrofit lighting assembly 100. Plug assembly 50 may include base 52 and integrated fastener 54. Fastener 54 is illustratively a screw or other threaded coupler, however, fastener 54 may be any post, prong, or linearly shaped device configured to be received within base 52. Fastener 54 is further coupled to bracket assembly 70 (FIG. 1) in order to properly position light source 110 within housing 14 and/or relative to assembly 100. Alternatively, plug assembly 50′ may include recess 56′ to receive fastener 54′ that is part of bracket assembly 70.

Base 52 is a mechanical insert or plug that is optionally threaded so as to be received within socket 12 of existing HID shoe box lighting unit 10. Socket 12 may be any mogul base, medium base, or other base member designed for use as a socket for an incandescent, fluorescent, or HID lighting unit. Illustratively, socket 12 may be a mogul base having interior threads in order to threadedly couple with threads along an outer perimeter of base 52. Base 52 may be comprised of polymers, metals or other alloy-based materials that are resistant to environmental conditions (e.g., temperature, pressure) and have a high tensile strength. The material also may be nonconductive. For example, in one embodiment illustrative base 52 is comprised of a modified diphenylmethane diisocyanate (MDI) terminated polyester prepolymer (e.g., Xthane IT-11×9.6). Base 52 may be cast, molded, or formed through other conventional processing techniques. Illustratively, base 52 has a cylindrical shape corresponding to the shape of an inner diameter of socket 12. While the exemplary embodiment of base 52 has external spiral threads for engaging the threads of socket 12, alternative embodiments of base 52 may be configured with an outer diameter that forms an interference fit within socket 12. One embodiment of base 52 is formed as a solid cylinder of material that encompasses fastener 54 (FIG. 2A). Alternatively, a second embodiment of base 52′ may be formed as an open cylinder of material in which fastener 54′ extends through recess 56′ at the center of base 52′ (FIG. 2B). Another alternative embodiment of base 52 includes a cap or clamp (not shown) that is positioned around and over the top of socket 12 and secured through crimping, gluing, or other means to socket 12. Fastener 54 may extend outwardly from the outer surface of the cap in order to couple with bracket assembly 70.

As previously detailed, retrofit lighting assembly 110 utilizes the location of socket 12 when providing ALT light source 110 within shoe box lighting unit 10. The location and orientation of socket 12 dictates the orientation of light emitted from housing 14, and therefore, socket 12 and/or its mounting plate 28 is used to quickly and properly orient and position ALT light source 110 after the HID light source has been removed. As such, plug assembly 50 provides a mechanism for mechanically coupling retrofit lighting assembly 100′ to socket 12 in the proper orientation. However, ALT light source 110 does not use socket 12 or plug assembly 50 to electrically couple with the power source.

Plug assembly 50 is configured to be coupled with bracket assembly 70 or 100′ in order to install ALT light source 110 within housing 14 of shoe box lighting unit 10 or any other HID lighting fixture. Bracket assembly 70 includes first bracket 72, second bracket 74, and adjustment bracket 76 positioned between first bracket 72 and second bracket 74. Bracket assembly 70 may be configured as a single, unitary assembly having fixed dimensions, or may be configured to adjust the relative positions of first bracket 72, second bracket 74, and adjustment bracket 76.

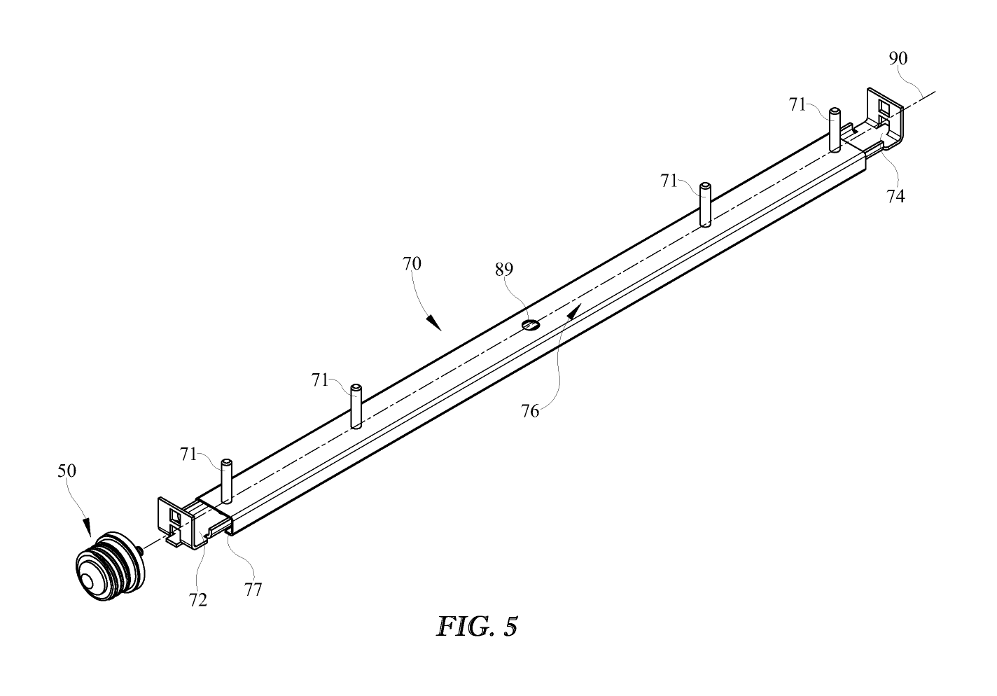

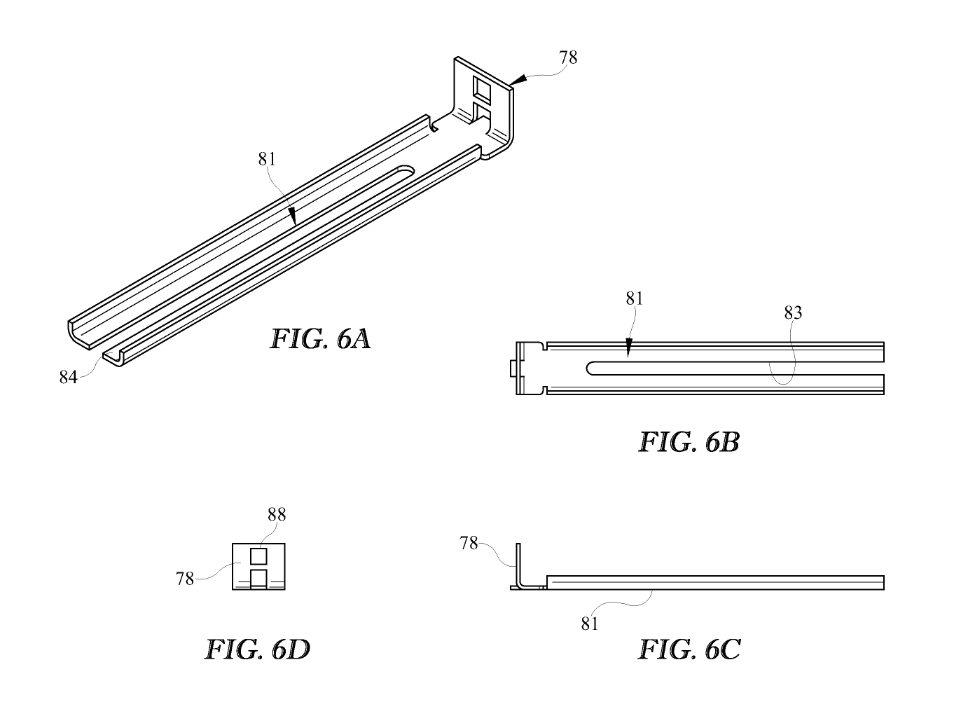

As is shown in FIGS. 5-6, first bracket 72 and second bracket 74 extend in opposite directions from adjustment bracket 76. More particularly, first bracket 72 extends in a first direction toward plug assembly 50 and second bracket extends in a second direction toward an opposing wall of housing 14. First bracket 72 is coaxial with second bracket 74 along a longitudinal axis 90 of bracket assembly 70. First bracket 72 and second bracket 74 include vertical members 78 and horizontal members 81 that may be configured in an L-shape or T-shape relationship. Horizontal members 81 extend outwardly in the respective first and second directions from adjustment bracket 76. More particularly, vertical members 78 are disposed at an angle relative to horizontal members 81, illustratively perpendicular with horizontal members 81. Vertical member 78 of first bracket 72 may extend downwardly toward bottom surface 20 of housing 14 when lighting assembly 100 is used with shoe box unit 10. Conversely, vertical member 78 of second bracket 72 may extend upwardly toward top surface 18 of housing 14 when lighting assembly 100 is in use with shoe box unit 10. Alternatively, both vertical members 78 may be positioned in the same direction with respect to horizontal members 80.

Adjustment bracket 76 includes one or more studs 71 and aperture 89 that facilitate securing ALT light source 110 to bracket assembly 70. Aperture 89, in the exemplary embodiment, is centrally located on adjustment bracket 76 and may be used to center and secure bracket assembly 70 within a lighting housing. In addition, brackets 72 and 74 may be secured in position by engagement of a stud or screw through guide 85 and/or aperture 89. To secure brackets 72 or 74, a fastener is attached to the underside of bracket assembly 70 to engage the respective bracket through guide 85 to adjustment bracket 76.

First bracket 72 and second bracket 74 may be comprised of metal or other materials configured to support light source 110 within housing 14. The exemplary embodiment of bracket assembly 70 is comprised of aluminum, however, other corrosion-resistant materials may be used. In one embodiment, one or more PIM studs (not shown) may be disposed on the lower surface of adjustment bracket 76 to retain brackets 72 and 74. In this exemplary embodiment, brackets 72 and 74 have a longitudinal bend and form a U-shape for greater tensile strength. Alternatively, such a bend may be in the shape of a T or L to achieve a similar strengthening (not shown).

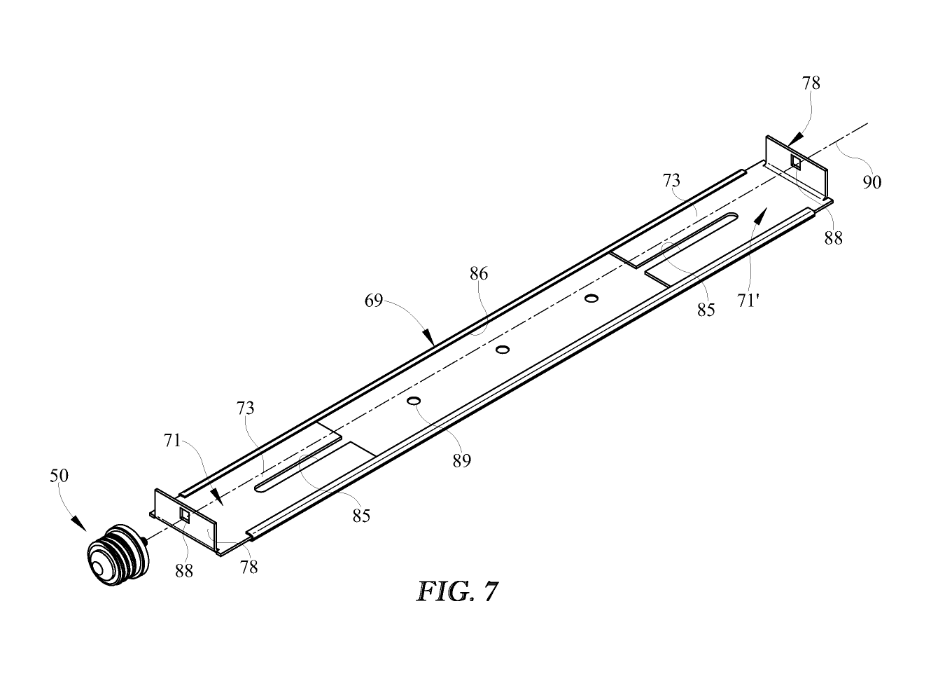

Referring to FIGS. 1, 7 and 11A-D, in an exemplary embodiment horizontal members 73 of first and second brackets 71, 71′ have a length that extends approximately six (6) inches, illustratively 6.13 inches, along longitudinal axis 90. Brackets 71, 71′ slide within sideways 86 defined by the edge of adjuster 69. Horizontal members 73 have a width of approximately 2.25 inches. Length and width of horizontal members 73 may be increased or decreased to accommodate different types of HID lighting assemblies. Additionally, each horizontal member 73 includes guide 85 that extends approximately five (5) inches along length. Guide 85 extends about five inches from an insertion end of horizontal members 73 and terminates approximately one (1) inch from each end surface 78 of horizontal members 73. Each end surface 78 of horizontal members 73 extends vertically approximately 0.75 inch. The length of horizontal members 73 extends beyond end surfaces 78 by approximately 0.13 inch, such that end surfaces 78 are not positioned at an extreme end of length of horizontal members 73. Additionally, the width of horizontal members 73 is greater than the width of end surfaces 78. In this exemplary embodiment, horizontal members 73 are about 2.25 inches wide and end surfaces 78 are about two (2) inches wide. Each end surface 78 of horizontal members 73 includes aperture 88 that is approximately 0.27 inches². Illustratively, apertures 88 have a square shape, although apertures 88 may have other shapes (e.g., circles). The length and width of horizontal members 73 and the dimensions of guides 85 and all other related components may vary to accommodate different HID lighting units and/or ALT light sources.

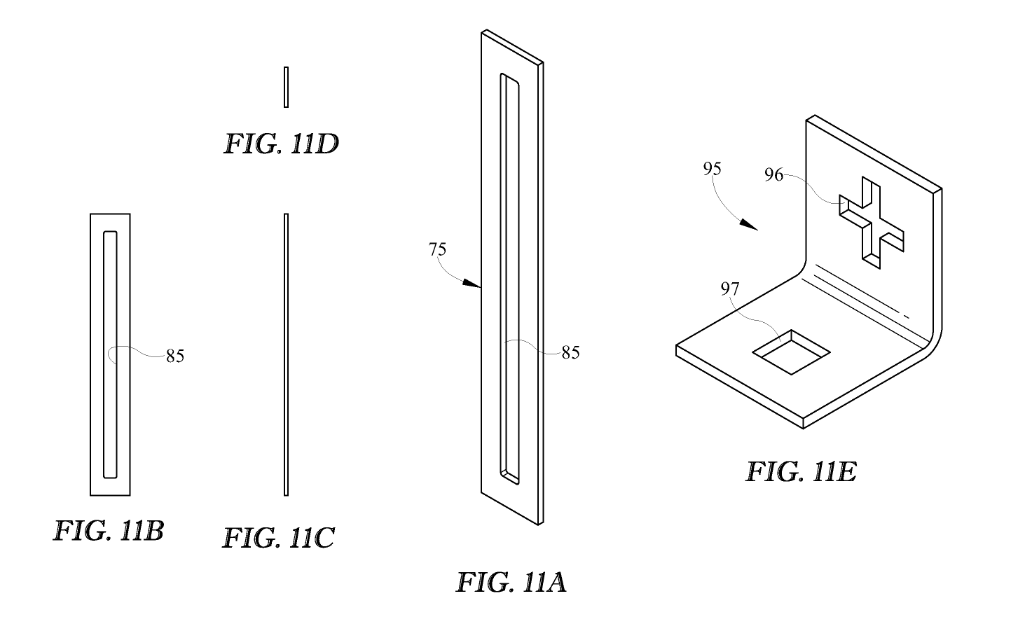

As shown in FIGS. 11A-E, vertical members 95 couple with horizontal members 75 through engagement with apertures 85. Vertical members 95 have a portion with slot 97 that extends perpendicularly to longitudinal axis 90. In this exemplary embodiment, vertical members 95 include a length of approximately 3.5 inches, although the length may be varied to accommodate different sizes and shapes of HID lighting assemblies. Additionally, illustrative vertical members 95 have a width of approximately two (2) inches. Similar to horizontal members 73, each vertical member 95 includes slot 97 that couples with apertures 85 of horizontal members 75. Conventional couplers (e.g., screws, nuts) (not shown) may be used to couple vertical members 95 with horizontal members 75. In this exemplary embodiment, guides 85 extend about 2.75 inches along the length of horizontal members 75, such that guides 85 terminate approximately 0.375 inch from each end of vertical members 75. Guides 85 have a width of approximately 0.25 inch. The length and width of members 95 and 75 may vary to accommodate different HID lighting units and/or ALT light sources.

Bracket assembly 70 may be assembled by inserting insertion ends of horizontal members 72 within tracks 86 of adjustment member 69. Horizontal members 72 may slide within tracks 86 and along length of adjustment member 69 until the desired length of bracket assembly 70 has been reached. In one exemplary embodiment, bracket assembly 70 may be adjusted from approximately 20 inches to approximately 12 inches. Apertures 89 of adjustment member 69 may cooperate with detent pins, studs, or other fasteners to secure bracket assembly 70 at a particular length or secure bracket assembly to the housing. More particularly, the studs, pins, or other fasteners may be positioned through apertures 89 and guides 85 of horizontal members 75 to secure horizontal members 75 to adjustment member 69. Alternative embodiments of bracket assembly 70 may use tension to secure horizontal members 75 to adjustment member 69. Vertical members 75 may be assembled with horizontal members 95 before or after horizontal members 75 have been inserted within tracks 86 of adjustment member 69. Conventional fasteners may be positioned through guides 85 of vertical members 75 and slots 97 of vertical members 95 to secure vertical members 95 to horizontal members 75 and fix the vertical positioning. Bracket assembly 70 may further include an angled bracket member 95 having slotted configuration 96 that may be X-shaped or resembling a cross (FIG. 11E), in addition to straight slot 97 or use other shapes for appropriate connection.

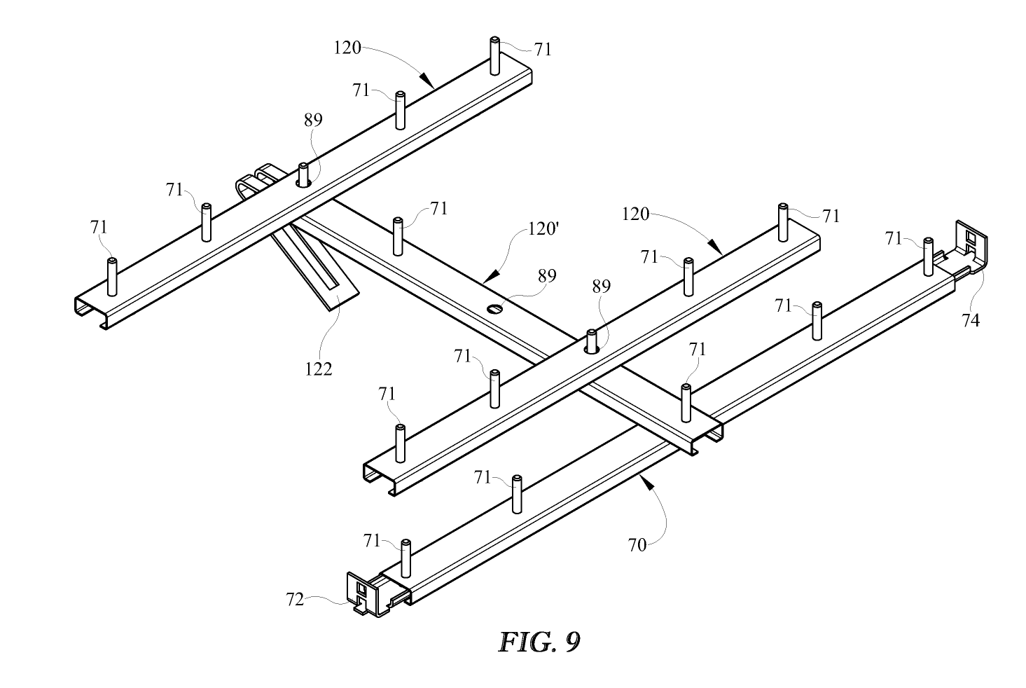

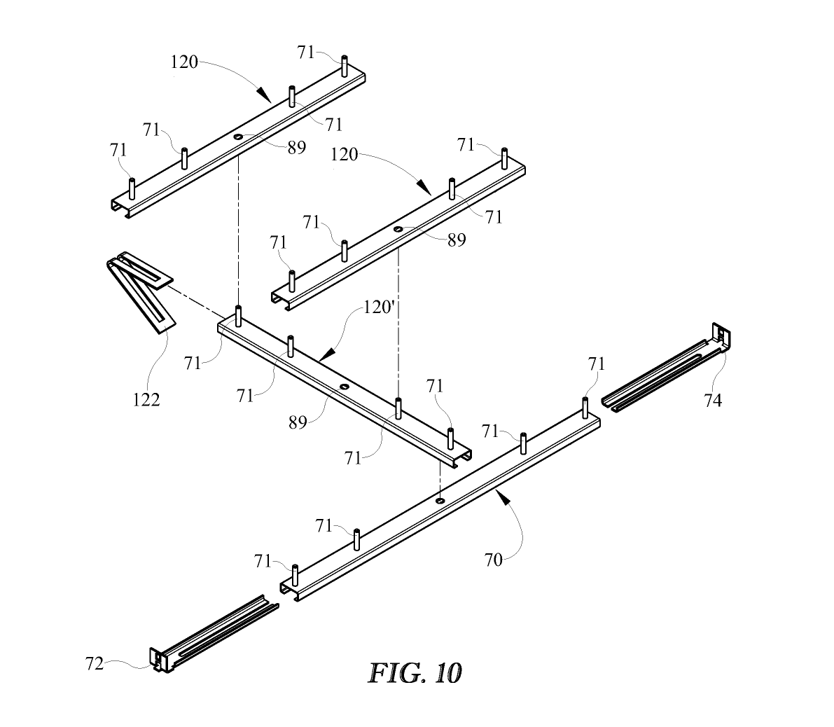

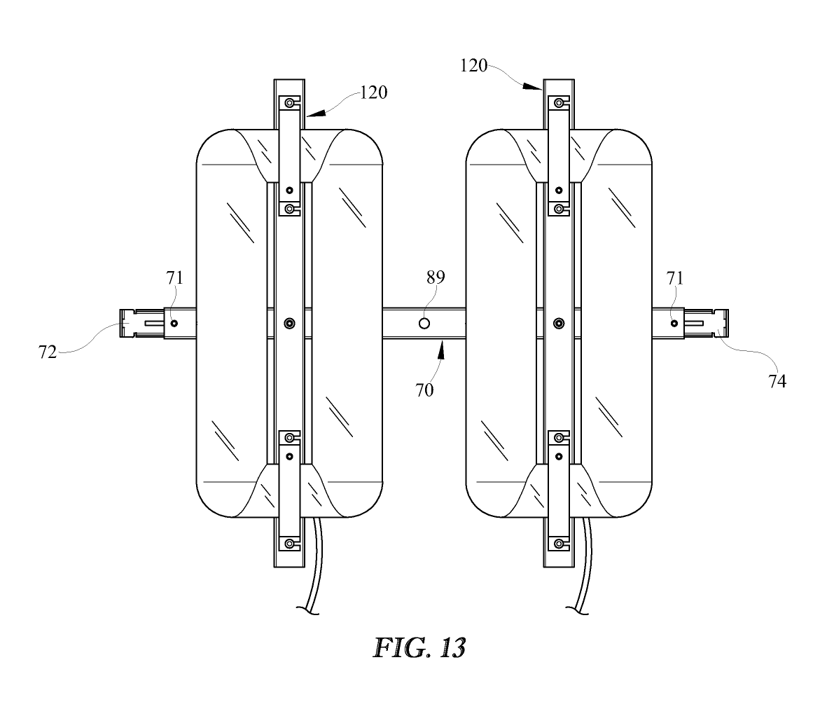

Bracket assembly 70 may further include a plurality of couplers 120, illustratively two couplers 120, for coupling multiple ALT light source 110 with bracket assembly 70 (FIGS. 9 and 10). In this exemplary embodiment, couplers 120 support light sources 110 in a manner similar to how bracket assembly 70 may support a single ALT light source 110. More particularly, couplers 120 may be attached to pegs 71, for example through bore 89, to be disposed transverse to adjustment bracket 76. Fasteners (not shown) may then fix the position of couplers 120 to bracket assembly 70. In one embodiment, coupler 120′ includes mounting extension 122 that may provide an additional attachment point for the combination of bracket assembly 70 and couplers 120 to be further secured to the body of the lighting unit (not shown) such as by screws, nails, rivets, or other connecting mechanisms. FIGS. 12 and 13 show how such a combination may be used to position multiple ALT light sources 110 within, for example, shoe box lighting unit 10.

With light source 110 secured to bracket assembly 70, light source 110 may be coupled directly to the power source or may be coupled to generator 22 with wires 24. Generator 22 may have a housing that is also comprised of reflective material and thereby serve as an additional reflector or insulator within housing 14.

With reference to FIGS. 3A and 3B, bracket assembly 70 may be coupled to cobra housing 62. Bracket assembly 70 may be coupled to plug assembly 50 in order to position light source 110 near socket 12 for proper orientation of ALT light source 110. Bracket assembly 70 may be coupled to plug assembly 50 with conventional coupling means (i.e., screws, welds, pins). Bracket assembly 70 may be adjusted, for example from the position of FIG. 3A, by sliding first bracket 72 and/or second bracket 74 relative to adjustment member 76 to fit light source 110 and bracket assembly 70 within housing 62. As shown in FIG. 3B, first bracket 72 engages socket 12 and second bracket 74 engages housing 62.

To replace the HID light source with ALT light source 110 and assemble a new retrofit lighting assembly 100 with shoe box lighting unit 10 or cobra 62, the power supplied to shoe box lighting unit 10 should be disabled or de-energized. Housing 10 or 62 may be opened to remove the HID light source (not shown) and other internal lighting components (e.g., reflector panels 26) from housing 14. Any wires, reflector panels, or other internal components may be replaced, if necessary, prior to re-installing these components in housing 10 or 62. Housing 10 or 62 and any lens of bottom surface may be cleaned before installing retrofit lighting assembly 100 within housing 10 or 62. Generator 22 may be affixed to plate 60 and secured within housing 10 or 62 by internally securing plate 60 to at least one of the side walls and/or top surface, generator housing 32 may then be secured over generator 22. Alternatively, generator 22 may be secured external to the housing given a proper generator enclosure (not shown). When generator housing 32 is used within housing 10 or 62, a grommet (not shown) may be provided within a central opening (not shown) of generator housing 32 in order to receive bracket assembly 70. Bracket assembly 70 is coupled to ALT light source 110 and oriented within housing 10 or 62, such that any wires or electrical connections of light source 110 that are necessary to illuminate light source 110 are positioned near generator 22, wires 24, and/or the power supply. First bracket 72 is positioned near socket 12 and/or generator housing 32 and second bracket 74 is positioned along an opposing wall of housing 10 or 62. First bracket 72 and second bracket 74 may cooperate with adjustment member 76 to correctly position and fit bracket assembly 70 and light source 110 within housing 10 or 62. Wires of light source 110 are electrically coupled with generator 22 and may be positioned through the central opening of generator housing 62. Reflector panels 26, 29 or 80 may be re-inserted within housing 14 relative to light source 110 in order to facilitate maximum light output from housing 14. Any bottom surface, including any lens, may be closed and secured to housing 10 or 62 may be activated or re-energized with the power source.

In use, housing 10 or 62 are positioned such that it faces outwardly or downwardly to emit light to a particular area. Once light source 110 is electrically coupled to generator 22 or another power source, light source 110 may be illuminated by triggering or activating generator 22. For example, the power source and/or generator 22 may be triggered by switches, timers, sensors, or other means.

FIG. 15 illustrates an embodiment of the present invention used with cobra lighting unit 30. Cobra lighting unit 30 includes features similar to those of shoe box lighting unit 10, with like reference numerals indicating like elements, except as described below.

As with shoe box lighting unit 10, cobra lighting unit 30 includes socket 12, housing 34, and bottom surface 36. Housing 34 has a semi-round or flat surface that couples with bottom surface 36. Similar to shoe box lighting unit 10, bottom surface 36 of cobra lighting unit 30 may also include a transparent surface or lens from which light is emitted. Rather than include reflector panels, illustrative cobra lighting unit 30 includes an internal reflective liner 38 that cooperates with ALT light source 110 and the location of socket 12 to emit a maximum amount of light outwardly from housing 34.

Cobra lighting unit 30 may be assembled and used in the manner similar to that described for shoe box lighting unit 10. For example, the HID light source may be removed from housing 34 in order to insert bracket assembly 70 and light source 110. Bracket assembly 70 is placed within housing 34 and coupled with plug assembly 50. Conventional mechanical couplers may be used to couple plug assembly 50 with bracket assembly 70. Additionally, light source 110 may be coupled to generator 22 and/or the power source using wires 24. As with shoe box lighting unit 10, cobra lighting unit 30 may be triggered with switches, sensors, or other power activator.

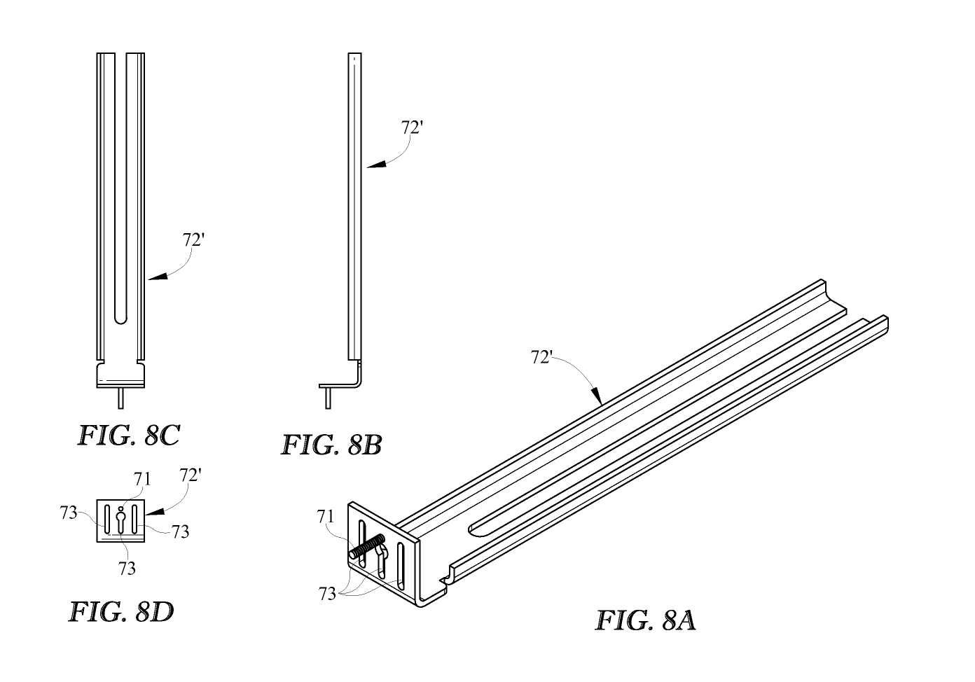

Alternatively, plug assembly 50 may or may not be used with bracket assembly 70, for certain ALT lighting applications such as shown in Acorn arrangement 140 (see FIGS. 14 and 8A-D). Bracket assembly 70, with or without plug assembly 50, may be coupled to ALT light source 110 with wires 24, which are directly coupled to either a generator (not shown in FIG. 14) or the power source. Light source 110 may be coupled to supports (not shown) to support light source 110 within the stand-alone plug assembly 50.

Illustrative retrofit lighting assembly 100 and stand-alone plug assembly 50 may each provide existing HID, fluorescent, and incandescent lighting units with more efficient light sources (e.g., plasma, LED, induction). Retrofit lighting assembly 100 provides an inexpensive way to utilize energy efficient light sources by re-using existing lighting fixtures and units.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A retrofit lighting assembly for use with a conventional lighting assembly including:
a base configured to engage a socket of the conventional lighting assembly;
a non-conventional light source; and
a bracket assembly coupled to the base and supporting said non-conventional light source within the conventional lighting assembly.

2. The retrofit lighting assembly of claim 1 wherein the conventional lighting assembly is selected from the group consisting of rectangular fixtures, cobra fixtures, High Intensity Display (HID), Area Lights, Decoratives, Post Tops, Acorns, Lanterns, Wall Packs, Dusk to Dawns, outdoor signage, and Security lights.

3. The retrofit lighting assembly of claim 1 wherein said bracket assembly includes a first end coupled to said base and a second end disposed opposite said first end and adapted for connection to the housing of a lighting assembly.

4. The retrofit lighting assembly of claim 1 further comprising a plurality of non-conventional light sources, at least one of said plurality of non-conventional light sources mounted on a coupling supported by said bracket assembly.

5. The retrofit lighting assembly of claim 1 wherein said bracket assembly comprises an adjuster member and first and second end bracket members, said adjuster member slideably receiving said first and second end bracket members.

6. The retrofit lighting assembly of claim 5 wherein said end bracket members have a bend portion.

7. The retrofit lighting assembly of claim 6 wherein said bend portion has the shape of one of a U, T, or L-shape.

8. A retrofit lighting assembly including:
a shoe box housing assembly having a socket;
a base configured to engage the socket; and
a bracket assembly coupled to the base and configured to support an Advanced Lighting Technology (ALT) light source within the shoe box housing assembly.

9. A retrofit lighting assembly including:
a cobra lighting unit housing assembly having a socket;
a base configured to engage the socket; and
a bracket coupled to the base and configured to support an Advanced Lighting Technology (ALT) light source within the cobra lighting unit assembly.

10. A method of retrofitting a lighting fixture with a replacement non-conventional light device comprising the steps of:
providing a base configured to engage a socket or socket base of the lighting fixture;
connecting a bracket to the base within the housing of the lighting fixture;
connecting the non-conventional light device to the bracket; and
expanding the bracket to engage the housing of the lighting fixture.
